(19) United States
(12) Patent Application Publication
(10) Pub. No.: US 2010/0285732 A1
(43) Pub. Date: Nov. 11, 2010

(54) Seamless Handover of Radio Broadcasts

(75) Inventors: Lee Corey Sinton, Berkshire (GB); Ahmar Ghafoor, Reading (GB); Neil Briffett, Surrey (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/446,992

(22) PCT Filed: Oct. 24, 2006
(86) PCT No.: PCT/IB06/02983

§ 371 Date: Jul. 27, 2010

(51) Int. Cl. H04H 20/71

(52) U.S. Cl. 455/3.01

(57) ABSTRACT

The invention provides a method for broadcasting via radio transmission, comprising the steps broadcasting data on a first radio frequency, transmitting an indication of a second frequency via said broadcast on said first frequency, establishing a synchronous second broadcast of said data on said second frequency, and discontinuing transmission of said broadcast on said first frequency. Also provided is an electronic device for broadcasting via radio transmission, comprising a receiver adapted for scanning a plurality of radio frequencies, at least first and second radio transmitters, a controller adapted for detecting available radio frequencies on which no interfering broadcasts or signals are currently received using said receiver, selecting a first detected available frequency, establishing a broadcast of data on said first frequency using said first transmitter, selecting a second detected available frequency, transmitting an indication of said second frequency via said broadcast on said first transmitter, establishing a synchronous second broadcast of said data on said second frequency using said second transmitter, and discontinuing the transmission on said first transmitter.

The present invention relates to radio transmission, particularly to a seamless handover between different transmission channels.

### BACKGROUND OF THE INVENTION

Mobile electronic devices which are capable of music and/or video playback have become very popular recently, with the IPOD™ by Apple® Computer Inc. being one of the most prominent examples. These media players are mainly intended for being used in conjunction with head- or earphones. For a typical mobile use of such devices, this is a preferable listening manner. However these players have become rather sophisticated recently, many of them comprise hard disks capable of storing e.g. gigabytes of music. Therefore, it seems logical that a user would want to use his player, on which a big amount or all of his own music/videos, games etc. is stored, as the source of media data also in other environments, and also for playing back music with normal speakers.

The user could use the earphone or line-out output to connect his player device with his hi-fi equipment or the like. However, cable connections are inconvenient, particularly in conjunction with small mobile player devices. Because of the wide variety of used plug/socket connector systems, this is also likely to cause incompatibilities between devices.

Another example would be to use such a player as a replacement for a CD-changer in a vehicle. However, many existing car radio systems still do not comprise any input interface to connect a mobile player. As one of the main advantages of mobile music players is the possibility to easily carry it along, it would be desirable if it could be coupled with other equipment in a standardized way, with some kind of common interface.

Therefore, wireless transmission of music or other media data from the player would be useful. As many audio playback devices like stereo systems and car radios comprise an FM tuner or receiver, a known implementation of such wireless transmission is to “mimic” the music player as a conventional FM radio station and to send the audio data encoded as a standard FM radio transmission.

In the United States of America (and also other countries, including the European Union) the usage of unlicensed (i.e. personal/private) FM-radio transmitters is allowed. In the U.S. the FCC (Federal Communications Commission) allows such devices according to FCC rule 15 (see section 15.239). Such a transmitter can thus be used for conveniently transmitting sound or music and in principle also other media content like video or data from any device wirelessly to an FM radio operating in the 88-108 MHz band, e.g. from a CD-player or an MP3-player. An example is the iTrip™ add-on accessory for the iPod™ by Apple®. This allows listening to music from such a device e.g. through a car FM radio. Due to the restricted transmission power with field strengths of about 250 μV/m in a distance of 3 meters, the transmission range of such private transmitters is small. Interference is therefore expected to be low. However, interference with licensed FM transmitters, e.g. a radio station, is not allowed. Regulations in other countries may be similar.

Conventional transmitters for that purpose simply transmit on a fixed frequency or frequency that can manually be chosen. This requires manually setting the corresponding transmission frequency on both the transmitter connected with the player device and the FM radio receiver. As described above, an interference with a licensed transmitter is not allowed, so the user has to perform a manual search for free frequencies before setting the frequency in order not to violate that regulation. This is very inconvenient.

Additionally, when the FM receiver is located in a car radio and the user is driving, that is, changing his location, the situation related to free frequencies will change over time. This will require re-tuning from time to time, e.g. because a licensed transmitter (e.g. a radio station) will come in range that is transmitting on the same frequency as the unlicensed private transmitter of the user. On the one hand, it is prohibited to continue using the FM transmitter on the frequency used by the licensed transmitter, as discussed above, and on the other hand, such interference will most severely decrease the quality of the signal received from the music player, as the transmission power of the private transmitter is substantially lower than that of licensed transmitters. Manual re-tuning will thus be unavoidable to maintain the quality of the transmission of audio data. However manual re-tuning while driving is to be avoided in order not to affect driving safety, and it is an inconvenience for the user.

Therefore it was suggested to make use of the Alternate Frequency feature (AF) of the Radio Data System (RDS). While this can avoid any manual re-tuning, it alone cannot ensure a seamless transition to the new station in the radio receiver. Particularly, gaps in audio broadcasts are disturbing and noticeable by a user and thus undesirable.

The present invention therefore provides means for ensuring a seamless transition between frequencies to avoid any noticeable gaps in the radio transmission, not only for transmitting audio data.

### SUMMARY OF THE INVENTION

According to a first aspect of the invention a method for broadcasting via radio transmission is provided, comprising:
broadcasting data on a first radio frequency;
transmitting an indication of a second frequency via said broadcast on said first frequency;
establishing a synchronous second broadcast of said data on said second frequency; and
discontinuing transmission of said broadcast on said first frequency.

By this method it can be ensured that a radio receiver the broadcast is intended for (e.g. an in-car stereo system) can follow the frequency jump from the first to the second frequency. With the prior art, the first transmission would simply be turned off, wherein the start of the transmission on the new frequency is performed with a short yet finite time delay. Simply turning off, without an alternate broadcast to switch to, might irritate the receiver. Through the overlap enabled by the present invention, that is, the time during which both transmitters are active and transmit the same information (called here a synchronous broadcast), it is ensured that any interruption of the reception at the receiver is kept to a minimum or even avoided completely. This depends on the actual capabilities of performing transparent frequency jumps of the radio receiver. It is to be noted that this method is to be performed in a single device, e.g. an FM transmission-enabled audio player.

According to an exemplary embodiment the method further comprises:
obtaining an indication of said first and/or said second radio frequency; and
selecting said first and/or said second frequency based on said indication.

Such an indication can be obtained in different ways according to the invention. A first example could be to receive the indication from another device, which can perform scanning for free channels for determining a first and/or a second frequency based thereon. As a second example the device performing the method itself could obtain the indication, e.g. by performing the scanning and pre-selecting first and/or second frequencies. The indication may hint to more than just the first and/or second frequency. Depending on the actual number of frequencies, the selecting may include only to use the indicated frequency/frequencies, or to select from a larger number of indicated frequencies.

According to an exemplary embodiment said indication comprises a list comprising at least one frequency.

According to an exemplary embodiment the method further comprises:
scanning a plurality of radio frequencies to detect available radio frequencies on which no interfering broadcasts or signals are currently received;

wherein said list comprises at least one detected available frequency.

To determine if a certain frequency is to be considered available, e.g. the signal level on that frequency may be compared to a pre-determined threshold. Frequencies having a signal level below the threshold can then be considered to be substantially “free”. As there will usually always be some signal level (e.g. noise), the threshold must be determined accordingly.

According to an exemplary embodiment the method further comprises:
storing a list of detected available frequencies or updating an already stored list.

This enables to maintain a kind of database of presumably available frequencies to choose from when deciding that a frequency jump should be performed. In possible embodiments the scanning for free frequencies may be performed less often than a check if the presently used transmission frequency is still free. Inter alia in such embodiments it is advantageous to maintain the list, instead of simply generating a new one at the next scanning.

According to an exemplary embodiment discontinuing transmission of said broadcast on said first frequency comprises:
shutting off said transmission; or
fading out said transmission.

In the present invention it is important that a synchronous broadcast is present on both the first and the second frequency, for a certain time span or overlap, during the frequency jump.

The kind in which the first transmission is discontinued may however be adapted, e.g. to the behavior of the FM receiver the broadcast is intended for. While simply shutting off may ensure the fastest possible switch to the new frequency, a more or less slow fading out might improve the chance that the FM receiver can follow smoothly.

According to an exemplary embodiment said data are one of or a combination of:
audio data;
video data; and
textual data.

The invention is not restricted to audio data alone; in fact all kinds of data can be broadcast in the inventive manner, also both digital as well as analogue. Data that is broadcast may be encoded (like PCM or MP3 for audio or MPEG-4 for video) and/or encrypted.

According to an exemplary embodiment the method further comprises:
receiving said data to be broadcast.

This particularly relates to cases wherein the broadcast transmitter is located in a kind of “accessory” device, which receives e.g. audio data to be broadcast.

According to an exemplary embodiment the method further comprises:
determining the velocity of the broadcast transmitter;

wherein said scanning is performed based on said velocity.

With respect to interfering broadcasts that originate from licensed radio stations which are stationary, it can be advantageous (e.g. with respect to power consumption) to perform the scanning based on the velocity, as this will have an influence on the frequentness of a change in available frequencies. While a stationary user will not encounter major changes in interference from radio stations over time, this can well happen to a fast moving user. In the former case scanning could be started again responsive to when the user starts to move again. As a scan requires an active receiver device which consumes power, performing the scan only as often as is appropriate can help save power, for example in power-restricted mobile devices.

According to an exemplary embodiment said broadcast is performed using frequency modulation, FM, radio transmission, and wherein transmitting said indication of said second frequency is performed according to the Alternate Frequency, AF, feature of the Radio Data System, RDS. This will also include sending the correct PI (program identification) code on both frequencies, the old and the new one. Details on how the PI code may be generated will be given below.

According to another aspect of the present invention a method for controlling a radio broadcast from an electronic device is provided, comprising:
scanning a plurality of radio frequencies to detect available radio frequencies on which no interfering broadcasts or signals are currently received; and
transmitting an indication of at least one detected available frequency.

The indication can then be received by another device as described above. The indication may be transmitted according to the Alternate Frequency (AF) features of RDS. This embodiment enables to split up the steps related to the actual transmission/frequency jump procedure and the scanning for/choosing of available frequencies, such that independent devices may perform them. An example for such devices may be a mobile phone or other device including an FM receiver, and an accessory device only including the transmitters for performing the data broadcast. In such a case the data to be broadcast off course have to be transferred from the mobile device to the transmitter accessory, which can be accomplished by any suitable prior art interfaces, both wired as well as wireless.

According to an exemplary embodiment the method further comprises:
repeating said scanning for updating said list of detected available frequencies.

In a simple embodiment the “updating” means overwriting the list of previous free frequencies by the new list. In other embodiments it may also mean to update only the changed frequencies, that is, delete currently blocked frequencies and add new free ones.

According to an exemplary embodiment said indication comprises a list of detected available frequencies.

According to an exemplary embodiment the method further comprises:
determining the velocity of the electronic device;

wherein said scanning is performed based on said velocity.

According to yet another aspect of the present invention a computer program product is provided, comprising program code means stored on a computer readable medium for carrying out the method steps described above when said program product is run on a computer device.

According to another aspect of the present invention an electronic device for broadcasting via radio transmission is provided, comprising:
at least first and second radio transmitters; and
a controller adapted for establishing a broadcast of data on a first frequency using said first transmitter, transmitting an indication of a second frequency via said broadcast on said first transmitter, establishing a synchronous second broadcast of said data on said second frequency using said second transmitter, and discontinuing the transmission on said first transmitter.

According to an exemplary embodiment the device further comprises:
an interface adapted for receiving an indication of at least one frequency;

wherein said controller is adapted for selecting said first and/or said second frequency based on said indication.

This embodiment is directed to a kind of accessory device, e.g. for use with mobile devices. The mobile device is then able to send the indication to be received as described here.

According to an exemplary embodiment said indication comprises a list of frequencies.

According to an exemplary embodiment the device further comprises:
a memory;

wherein said controller is adapted for storing said received list in said memory and/or updating an already stored list based on said received list.

According to an exemplary embodiment said interface is selected from the group comprising:
an optical wireless interface;
a Bluetooth interface;
a wireless local area network, WLAN, interface;
a wire-based interface;
a Universal Serial Bus, USB, interface; and
a radio interface.

While these are prominent examples of interfaces suitable for the present invention the invention is not restricted thereto. Other interfaces suitable for transmitting the indication can be used as well. In certain embodiments this interface can also be adapted for at least partially controlling the device, e.g. from a mobile phone. Furthermore, wired connections can also be used to provide power to the device, thus enabling to omit any battery. As the unlicensed transmitters have only a very limited transmission power, overall power consumption is expected to be low, as well. This applies to cases where the device of the invention is a kind of accessory device. The device may also be installed in an electronic device, where data and power interface can be implemented internally as should be apparent to the artisan.

According to an exemplary embodiment discontinuing comprises shutting off or fading out the transmission power of said second transmitter.

According to an exemplary embodiment said transmitters are adapted for frequency modulation, FM, radio transmission, and said controller is adapted for transmitting said indication of said second frequency according to the Alternate Frequency, AF, feature of the Radio Data System, RDS. The transmitters are also adapted for sending a PI code of the RDS system in order to enable the FM receiver to identify the correct new frequency.

According to an exemplary embodiment the device further comprises:
a receiver adapted for scanning a plurality of radio frequencies;

wherein said controller is adapted for controlling said receiver for detecting available radio frequencies on which no interfering broadcasts or signals are currently received, and for selecting said first and/or said second frequency from detected available frequencies.

According to an exemplary embodiment the device further comprises:
an interface adapted for receiving velocity information;

wherein said controller is adapted for performing said detecting of available radio frequencies based on said velocity information.

As an example, the device could be connected with the odometer of a car in order to determine the velocity.

According to an exemplary embodiment the device further comprises:
a memory for storing a list of detected available frequencies;

wherein said controller is adapted for storing detected available frequencies in said memory and/or updating an already stored list.

According to another aspect of the present invention an electronic device for controlling a radio broadcast is provided, comprising:
a receiver adapted for scanning a plurality of radio frequencies;
an interface; and
a controller adapted for controlling said receiver for detecting available radio frequencies on which no interfering broadcasts or signals are currently received, and for transmitting an indication of at least one detected available frequency via said interface.

According to an exemplary embodiment said interface is selected from the group comprising:
an optical wireless interface;
a Bluetooth interface;
a wireless local area network, WLAN, interface;
a wire-based interface;
a Universal Serial Bus, USB, interface; and
a radio interface.

According to an exemplary embodiment the device further comprises:
a component adapted for determining the velocity of the device; and

wherein said controller is adapted for performing said detection of available frequencies based on said velocity.

According to an exemplary embodiment the device further comprises:
a memory for storing a list of detected available frequencies;

wherein said controller is adapted for storing detected available frequencies in said memory and/or updating a stored list.

According to another aspect of the present invention an electronic device for broadcasting via radio transmission is provided, comprising:
a receiver adapted for scanning a plurality of radio frequencies;
at least first and second radio transmitters;
a controller adapted for detecting available radio frequencies on which no interfering broadcasts or signals are currently received using said receiver, selecting a first detected available frequency, establishing a broadcast of data on said first frequency using said first transmitter, selecting a second detected available frequency, transmitting an indication of said second frequency via said broadcast on said first transmitter, establishing a synchronous second broadcast of said data on said second frequency using said second transmitter and discontinuing the transmission on said first transmitter.

According to an exemplary embodiment said transmitters are adapted for frequency modulation, FM, radio transmission, and said controller is adapted for transmitting said indication of said second frequency according to the Alternate Frequency, AF, feature of the Radio Data System, RDS.

According to an exemplary embodiment said receiver is adapted for performing said scanning without interrupting said broadcast. As the transmitted signal is in principle known, regarding its power and characteristics, it may be possible to “blend out” the signal thus enabling scanning also the currently used frequency. Otherwise the receiver may be adapted to exclude certain frequencies from the scan, at least said first radio frequency. Also mixing products and harmonics may cause interference and may therefore be excluded as well.

In the present invention it is also possible to stop sending the PI code on the first frequency, after establishment of the synchronous second broadcast (sending the correct PI code). This can also be used to cause the FM receiver to follow to the new frequency, irrespective of the transmission power.

### BRIEF DESCRIPTION OF THE DRAWINGS

The invention can be more fully understood by the following detailed description of exemplary embodiments, when also referring to the drawings, which are provided in an exemplary manner only and are not intended to limit the invention to any particular embodiment illustrated therein. In the drawings

FIG. 1 represents a prior art reception situation; FIG. 2 illustrates a use case scenario of the prior art solution;

FIG. 3a illustrates stage 1 of an AF jump procedure as performed with a prior art solution;

FIG. 3b illustrates stage 2 of an AF jump procedure as performed with a prior art solution;

FIG. 4a illustrates stage 1 of an AF jump procedure of the invention using two transmitters;

FIG. 4b illustrates stage 2 of an AF jump procedure of the invention using two transmitters;

FIG. 5 illustrates an exemplary embodiment of the invention as a block diagram including multiple separate antennas;

FIG. 6 illustrates an exemplary embodiment of the invention as a block diagram including a shared transmitter antenna;

FIG. 7 illustrates an exemplary embodiment of the invention as a block diagram including a shared transmitter/receiver antenna;

FIG. 8 illustrates an example embodiment in form of an add-on accessory for mobile devices and a corresponding mobile device;

FIG. 9 illustrates an alternative embodiment in form of an add-on accessory for mobile devices and a corresponding mobile device;

FIG. 10 is a flow diagram of an embodiment of the method of the invention; and

FIG. 11 is a flow diagram of another embodiment of the method of the invention.

### DETAILED DESCRIPTION OF THE INVENTION

It is to be noted that the following description of the invention will mainly focus on the transmission of audio data as an example. However, the invention is not restricted to audio data, it can as well be used for any other kind of radio broadcast, be it video, multimedia or other data content.

The conventional implementation makes use of only one transmitter which (in certain advanced conventional arrangements) includes received signal strength indicator (RSSI) scanning capabilities to allow the device to locate ‘quiet’ and free channels to transmit on. In advanced prior art solutions receiver and transmitter are separated in order to allow scanning for free frequencies without necessarily interrupting the transmission. However, there are limitations and drawbacks to using only a single FM transmitter device (FMTx) which has the potential to limit the experience for the end user.

In all prior art solution, when using only a single transmitter the transmission has to be stopped at least for a short time span in order to restart the transmission on another frequency. Thus, when the actual frequency jump takes place the transmitter has to stop transmitting on the currently used channel and then switch to the new channel which will cause any transmitted signal to be momentarily interrupted. There will thus always be an interruption of short yet finite length. This will cause both data loss and irritation and/or discomfort to the user.

The main idea of the invention therefore involves utilizing at least two FMTx devices and optionally at least one FM radio receiver device (FMRx) device in order to improve the user's experience and transparency of operation when using RDS capable FMTx. This will allow the user e.g. to listen to audio content from his/her handset, mobile device etc. via a typical RDS capable FM receiver such as an in-car stereo system, without any manual interaction required, and with little or even no interruption in the reception at all.

The inventive concept relies on having at least two radio transmitters and optionally one radio receiver. This implementation allows for a seamless channel jump which results in little or no interruption to the transmission and hence will improve the user's experience.

If the user chooses to initiate a channel jump manually, perhaps because he is experiencing a poor signal quality, or if the system has automatically initiated the jump, then an available free channel in the list of alternate frequencies can be chosen to transmit using the second transmitter. The information as currently transmitted by the first transmitter is also fed to the second transmitter. In the context of this invention this is also called a “synchronous” transmission or broadcast. In other words, the same data is transmitted by the second transmitter as by the first transmitter, regarding the actual data content as well as the timing thereof. The second transmission is thus performed synchronously to the first transmission.

Particularly in the case of analogue transmission the actual transmission can not be “the same” information, due to the unavoidable variations in analogue transmission. However, also in case of a digital transmission, which includes any RDS data sent together with an analogue FM transmission, there may be minor differences not affecting the actual media content of a transmission. For example, the transmission on the second frequency does not have to transmit the alternate frequency information pointing to the second frequency itself, which should be apparent. Therefore “synchronous” in the context of the invention mainly relates to the data content (e.g. audio data) as well as the timing of the transmission.

The first transmitter is then turned off or the power is lowered to the point until the RDS capable receiver looks for the next channel to tune in according to its stored AF list and performs the channel jump to the second frequency on which it will find the signal already being transmitted by the second transmitter along with the same information. The user will hardly be aware that the channel jump has taken place or even be unable to recognize it at all.

In the following an exemplary procedure of an AF jump according to an embodiment of the invention shall be detailed:
The user is listening to an audio transmission being transmitted from the first FMTx device in the handset, received by an RDS capable FM receiver, e.g. an in-car stereo.
The FM receiver in the handset is scanning periodically in the background for clear ‘quiet’ channels and updates the current AF list in the handset. This happens transparent to the user.
The AF list is transmitted to the FM receiver via RDS.
The user or the mobile device decides that the transmission is becoming unacceptable in audio quality due to interference and manually initiates the AF jump. Alternatively the mobile device itself automatically determines that transmission is becoming unacceptable and in response initiates the jump.
The second FMTx device is then set to transmit on a selected free channel the modulated information (in this case analogue audio data in the form of music) along with the current RDS data, i.e. PI, PS, PTY and AF list information.
The first FMTx device is then set to stop transmission of the current information on the current channel. This can be done by reducing either the power level more or less abruptly up to stopping the FM or turning off the main carrier altogether.
The FM receiver the user is listening to will then jump to the next AF without the user knowing the jump has taken place since the new channel being jumped to already has a valid transmission being broadcast on it, broadcasting the same information as the original frequency broadcast, i.e. in a synchronous manner. Depending on the actual implementation of the FM receiver in the car stereo, including mainly the time required for performing a frequency jump and whether this can be handled seamlessly, the frequency jump will hardly be noticeable or even completely inaudible.

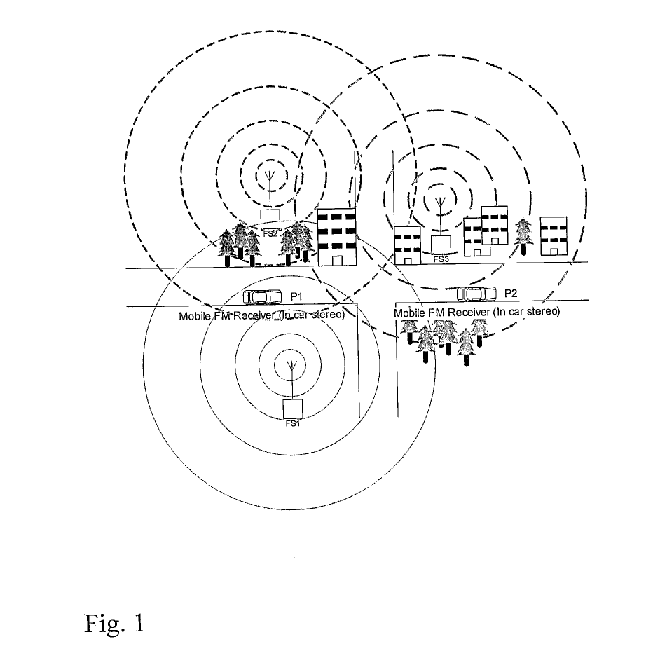

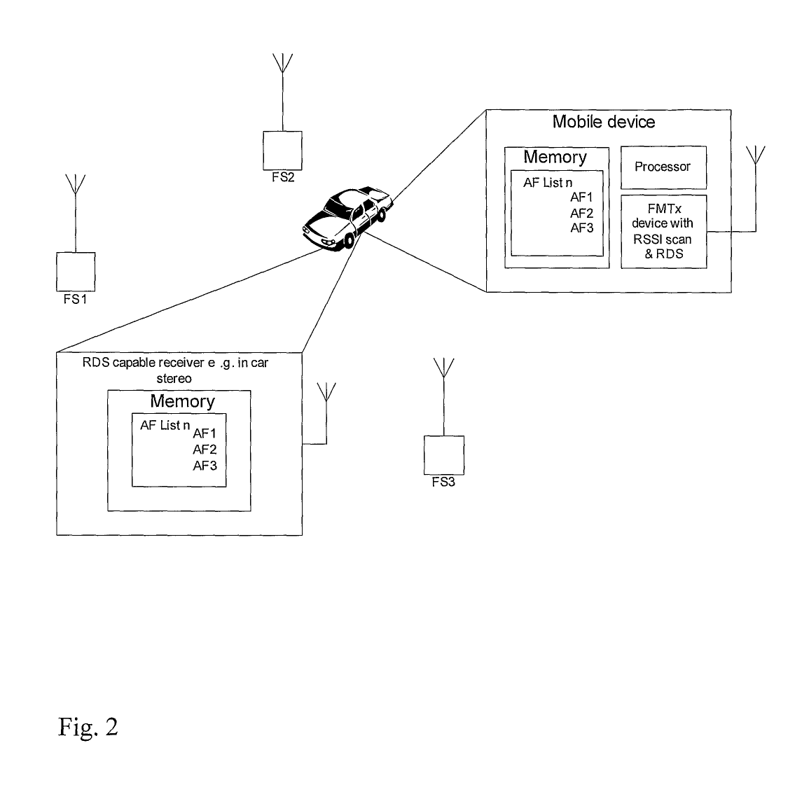

FIG. 1 shows the situation with a conventional implementation of a low power FM transmitter. Radio stations broadcast their RDS data along with their audio content. The AF list which is part of the RDS data is used by the FM receivers to be aware of where the same station can be found on (a) different frequency/frequencies. This allows the user to constantly listen to the chosen station while roaming, without the need for any manual intervention. When the chosen station on the currently tuned frequency becomes weak or the signal is interfered with, the FM receiver looks for the next best AF to tune the FM receiver to in order to provide the user with a better and cleaner signal.

In FIG. 1 FS1 and FS3 are radio stations that are all broadcasting the same information for a particular radio station that the FM receiver in the car (the in-car stereo) is currently tuned to. FS2 could be considered as an interfering transmitted signal that may be on the same frequency as FS1 but does not contain the same data information as FS1 and FS3. As the user (i.e. the driver of the vehicle) roams, the FM receiver will experience differing qualities of the FM transmission due to other interfering signals, reflections and/or weakening of signals. Since the user has initially tuned to and is listening to FS1 (the closest and strongest signal) at position P1, the FM receiver will begin to receive interference from FS2. As the user drives the vehicle towards P2 they will begin to be within range of FS3. If the signal from FS2 becomes poor enough (either due to interference from FS2 or because the signal is getting too weak) the FM receiver will then automatically retune to the frequency of FS3 which would have been transmitted to the FM receiver via RDS when it was tuned to FS1. Irrespective of where the vehicle travels and provided there are radio transmitters within range that are transmitting the same program station along with the RDS data, the user will always be able to stay tuned to the radio station of his choice.

FIG. 2 shows a use case scenario with the prior art solution wherein a user has a mobile device capable of FM radio transmission which is being used in a moving vehicle such as a car. The mobile device comprises a combined transmitter/receiver or transceiver, respectively. For example this can be a transmitter having no “full-featured” receiver component, but wherein the receiver component is suitable for a basic received strength signal indication (RSSI) scan. The mobile device has obtained a list of available free channels (frequencies AF1, AF2 & AF3) which are clear of interference from transmitting radio stations transmitting on their own frequencies FS1, FS2 & FS3.

Due to the fact that the receiver is not implemented independently of the transmitter, this prior art solution requires stopping the transmitter in order to enable the receiver to scan for free frequencies. That is, an interruption in the radio broadcast is inevitable.

Once the mobile device has obtained an AF list (at least one alternate frequency) and the AF list has been transmitted to the FM receiver via RDS, the next problem is causing the FM receiver to jump to an available AF. The single FM transmitter must stop transmitting on its current frequency and then begin transmission on one of the frequencies in the AF list, thus causing the FM receiver to retune automatically. Due to the implementation with only a single transmitter this will also cause an undesirable ‘break’ in the audio transmission.

The present invention can substantially reduce or even eliminate such breaks in the transmission, even during frequency jumps, thus providing a seamless channel handover.

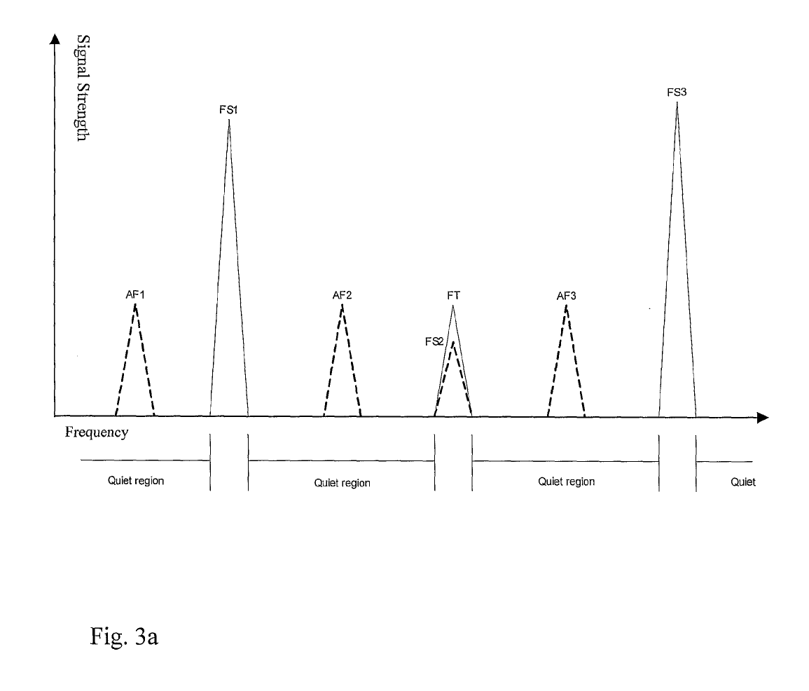

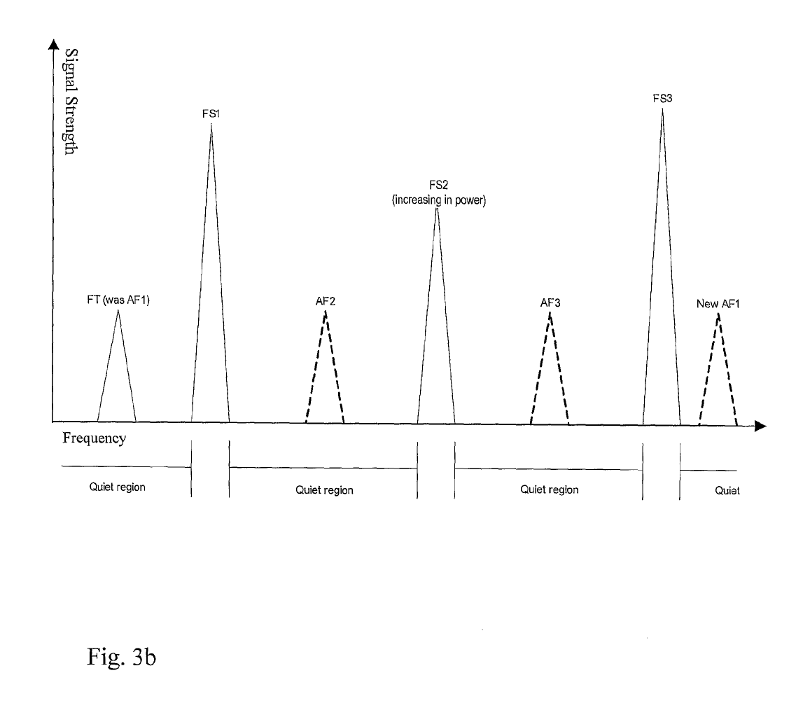

FIG. 3a shows a signal strength diagram of the transmitting stations (FS1, FS2 & FS3) and how FS2 is beginning to break through into the current FMTx transmission FT. In this and the following figures, the horizontal axis corresponds to the frequency of transmission and the vertical axis corresponds to the received signal strength. In the depicted situation of FIG. 3a, the transmission is performed on the frequency FT (shown as a solid peak). There are stations transmitting on FS1 and FS3 (also solid peaks). Another radio station is transmitting on the frequency FS2 (shown as a dashed peak) which is identical to the frequency currently used for the radio broadcast of the mobile device. Quiet regions are indicated in the figure, that is, regions showing no (licensed) radio broadcasts or other interfering signals. Within these quiet regions, three alternative frequencies AF1, AF2 & AF3 are located.

As can be seen, in the depicted situation the transmission power of FS2 is reaching that of FT, thus requiring a frequency jump. This may occur due to the traveling vehicle moving into an area where FT is already being used by a legal radio station (FS2) and consequently the signal of FS2 is becoming stronger. Alternate Frequencies have already been obtained by the mobile device and transmitted via RDS to the FM receiver (in this case a car stereo). These are shown as AF1, AF2 and AF3. In the current art, there is only one transmitter, which means that transmission on FT must be stopped and one of the AF's must be selected. Assuming AF1 is the next best choice, the FM transmitter in the mobile device will need to be retuned to the frequency of AF1.

In FIG. 3b the situation after the frequency jump to AF1 is depicted. The device now continues its transmission on frequency FT (former AF1). The transmission power of FS2 has increased compared to FIG. 3a. It is also possible at this point that a new scan has been performed to find the next best AF list and as a result of performing the scan a new AF 1 has been located. This new AF list will then be transmitted to the FM receiver via RDS thus updating its own internal AF list ready for the next AF jump.

The situation depicted in FIGS. 3a and 3b is handled by an FM transmission device having only a single FM transmitter, by switching off the current frequency and continuing on the new selected frequency after a short break. However, in this case an audible or otherwise recognizable break in the radio transmission would be inevitable, as the transmitter takes a finite time to perform the switchover.

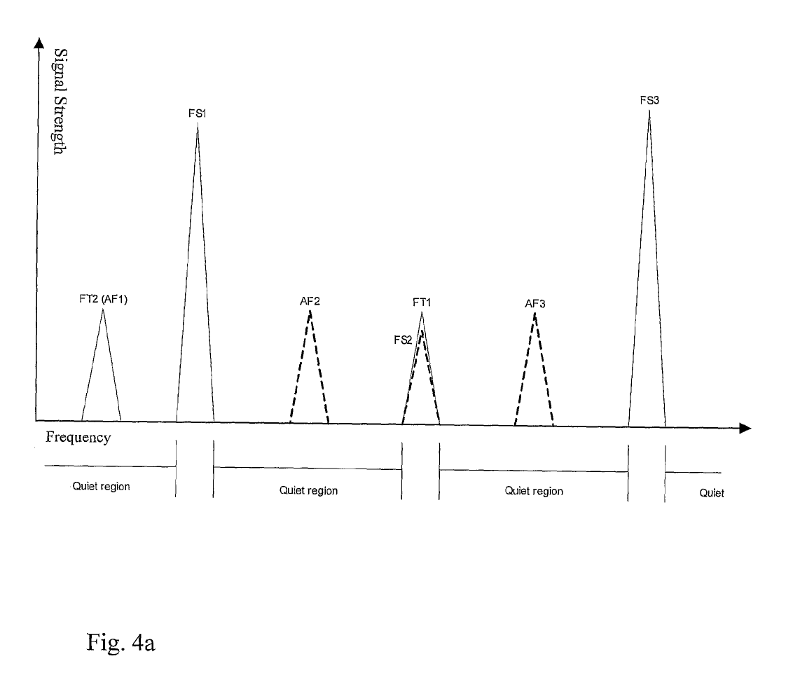

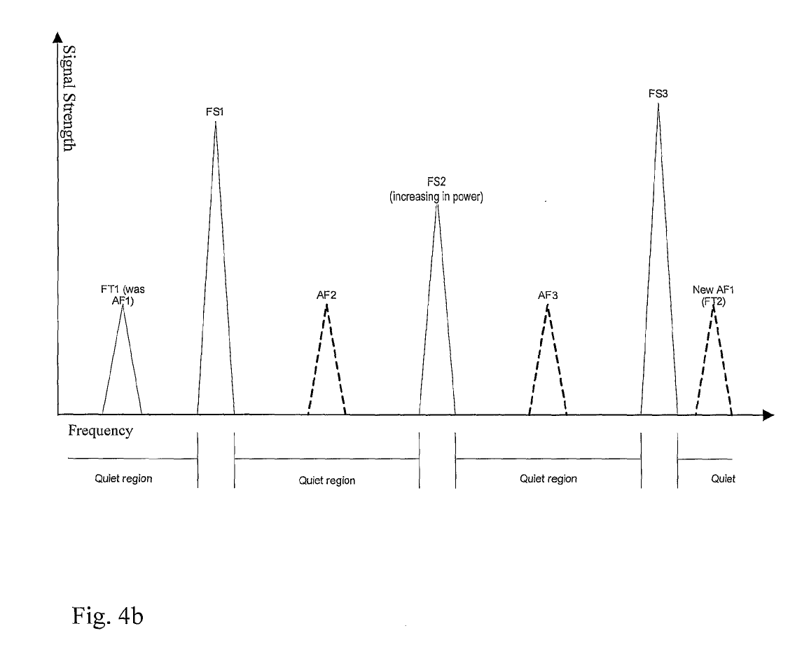

In FIGS. 4a and 4b it can be seen how using multiple FM transmitter devices (FMTx) according to the invention improves the transition or ‘handover’ for the AF jump in a more seamless and less intrusive manner. This will improve the user's listening experience.

The situation is the same as has already been explained in conjunction with FIG. 3a. However, there are now two transmitters available, according to the invention. Due to this fact the current transmission or broadcast is now indicated by FT1 (using the first transmitter).

FIG. 4a shows that, as interference from FS2 is beginning to break through and the AF jump is initiated, a concurrent transmission on AF1 (FT2) is started with the second transmitter. That is, the second transmitter starts a broadcast synchronous to the first transmitter.

Then, the transmission power of the first transmitter or the signal strength of FT1, respectively, is reduced substantially below the transmission power of the second transmitter or even removed completely, thus forcing the FM receiver to jump to the already active alternate frequency (AF) of FT2 which was listed in the AF list as AF1 (not shown here).

It will depend on the actual RDS AF implementation of the car stereo or other receiver at which point the change to the new frequency takes place. Therefore, in order to force the switch, irrespective of the receiver, it may be required to lower the transmission power of the first transmitter down to zero, i.e. until the transmitter is actually turned off. In order to enable the FM receiver to follow, in other words to be able to recognize that the transmission power of transmitter #1 is fading, it may also be required to configure the rate and/or profile of the fading out process of the transmission power accordingly.

The situation after the frequency jump is depicted in FIG. 4b. The radio transmission is now performed on frequency FT1 (former AF1/FT2). It has to be noted that of course the same transmitter (second transmitter) is used here that was activated in the situation of FIG. 4a. However, in the context of the invention the new “first” frequency is now the one used by the “second” transmitter as in FIG. 4a (former FT2). Or in other words, after any frequency jump the active transmitter is considered to be the “first” transmitter (FT1) and the used frequency is also considered to be the “first” frequency. The “second” transmitter/frequency is always the transmitter or frequency, respectively, that will be switched to when a situation as in FIG. 3a occurs.

The FM receiver within the mobile device could now perform a background scan of the available band to build a new AF list and hence replace AF1. The background scan would require no interruption in the transmission. FIG. 4b shows how the primary transmission is now on FT1 (was AF1/FT2 in FIG. 4a) and how the background scan has located a new AF for AF1 that would be chosen for the “second” transmitter (FT2) when a similar or identical scenario of interference occurs. Again, the “second” transmitter is a logical second transmitter; it is preferably the same physical transmitter that was the first transmitter before the interference situation in FIG. 4a.

The device will continually behave in this manner, always providing a good interference-free frequency for the next transmission to take place. Both transmitters, in the time span during which they operate simultaneously, always transmit substantially the same information synchronously, and with regards to RDS information, e.g. PI, PS and PTY data. In exemplary embodiments the synchronous second transmission may already carry another alternative frequency, thus the transmitted information would not exactly be the same. However, usually the actual media content will substantially be the same (e.g. for analogue transmissions) or even identical (e.g. in digital transmissions), in order to enable a smooth transition unnoticed by the user. It must be noted that once the AF jump has taken place the previously used transmitter can be switched off in order to conserve power and is only turned on again to allow the seamless AF jump to take place. This means that the transmitters each ‘toggle’ or take turns in transmitting.

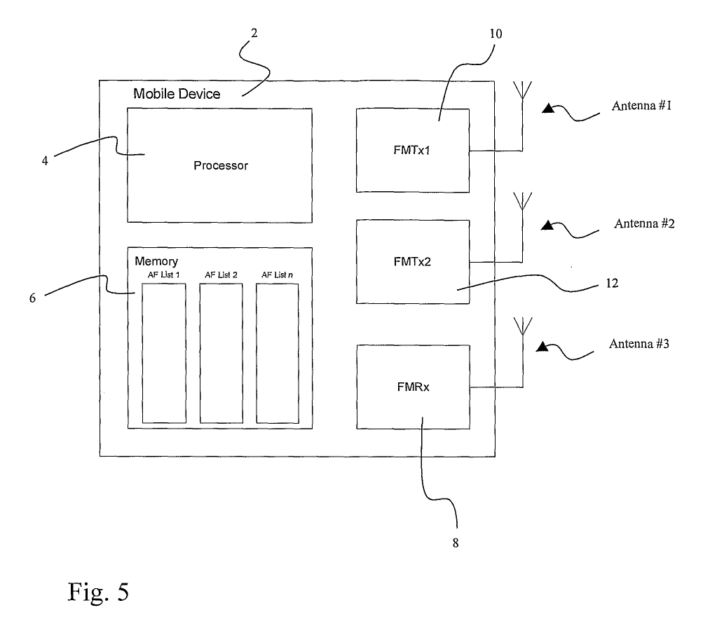

FIG. 5 shows an exemplary embodiment of a device according to the present invention, installed in a mobile device 2. The device comprises a controller or processor 4, a memory 6, first and second FM transmitters 10, 12 and an FM receiver 8. In this embodiment each of the transmitters 10, 12 and the receiver 8 have their own dedicated antenna (antenna #1, #2, #3). The processor 4 is adapted for controlling the receiver 8 to scan the available frequency band for channels free of interference. The frequencies found in this way are saved in an alternative frequency list AF List 1.

Using more than an AF list enables to use different “default” lists. Such a default list may be defined by the user. It may be used after start-up of the device.

Due to the separate implementation of receiver 8 and transmitters 10, 12 the device is able to perform such a scan also without interrupting a broadcast with one of the transmitters. This may be seen as a kind of “background” scan. In case it is detected that the currently used frequency is experiencing rising interference, e.g. by a local radio station coming into range, a frequency jump is initiated. An alternative frequency is chosen by the processor 4 from the AF list in memory 6.

It is also possible to implement a kind of “frequency hopping” scheme. That is, the frequency is changed, e.g. on a regular time basis, irrespective of any interference occurring. This also enables to scan the frequency just left for interference, as the transmitter can be shut down after the jump and does not produce any disturbances. The frequency jump can be initiated depending on certain circumstances, e.g. on a regular or pseudo-random time basis. In embodiments wherein the velocity of the transmitter can be evaluated, the rate of the jumps can be associated with the velocity. That is, when used e.g. in a fast moving vehicle the jumps are performed more often as when just barely rolling while stuck in a traffic jam.

It is assumed that the current broadcast is performed using transmitter 10. The processor 4 transmits an indication of the selected alternative frequency, for example called AF1, via the current broadcast over transmitter 10. It is to be noted that, according to the invention, it is also possible to transmit at least one alternative frequency or even a complete list of currently available alternative frequencies continuously. In this manner it can be ensured that any RDS capable receiver is always provided with a list of free frequencies.

Transmitter 12 is now activated, and starts a substantially identical and synchronous broadcast on the selected alternative frequency AF1. Processor 4 now reduces the transmission power of transmitter 10, in order to force the RDS capable FM receiver to switch to the new frequency. The actual profile of this reduction (slow/fast) can be configured to ensure maximal reliability, or in other words, to ensure that the FM receiver can follow.

The profile may be selected by the user from a number of default profiles. Thus, the user may try a first profile. If the user finds out that the first profile doesn't work for him, he can select a second profile, and so on. In this way, the user may find out which profile works best together with his RDS capable FM receiver, e.g. his car stereo receiver. After a pre-determined amount of time that is sufficient to have the receiver change to the new reception frequency, the first transmitter 10 can be de-activated in order to reduce power consumption.

In advanced embodiments this time amount (which may be dependent on the actual FM radio receiver e.g. car stereo) may also be part of the profile. As this time amount should be as short as possible, e.g. with respect to power saving, it may so be adjusted to the actual user needs.

Depending on the capabilities of the RDS receiver this frequency handover can be performed practically inaudible or seamless, respectively.

To reduce the costs of a device of the invention, it is possible to use an implementation not including a separate FMRx block. This can be achieved by integrating the reception functionality into the transmitters, in other words to rely on the FMTx's being able to perform an RSSI scan. It has to be noted that the receiver component in the present invention does not need to be a “full-featured” receiver, as it is only used for detecting free frequencies, wherein any other capabilities are less important.

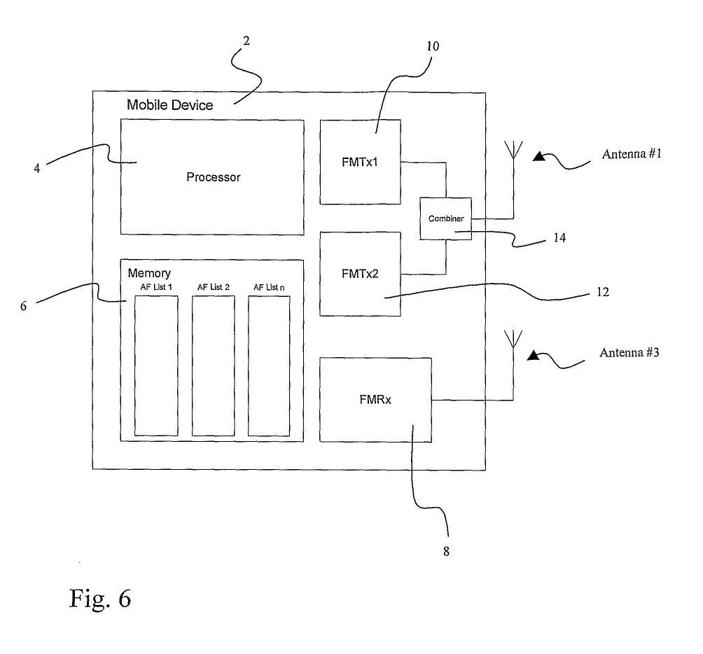

FIG. 6 shows an alternative of the embodiment of FIG. 5, wherein the transmitter blocks 10, 12 are sharing a single antenna #1, thus a second antenna as in FIG. 5 may be omitted. This can be achieved by connecting the transmitters 10, 12 with the antenna #1 through a combiner module 14. Otherwise this embodiment is similar to that in FIG. 5.

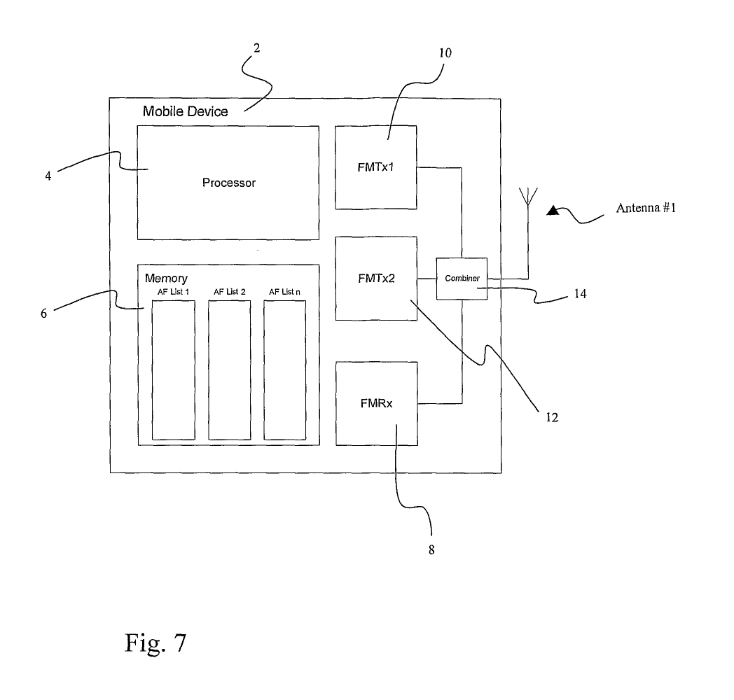

FIG. 7 shows yet another alternative embodiment, wherein the transmitters/the receiver are sharing only a single antenna #1. Transmitters 10, 12 and receiver 8 are connected with the antenna #1 through a similar combiner module 14 as in FIG. 6.

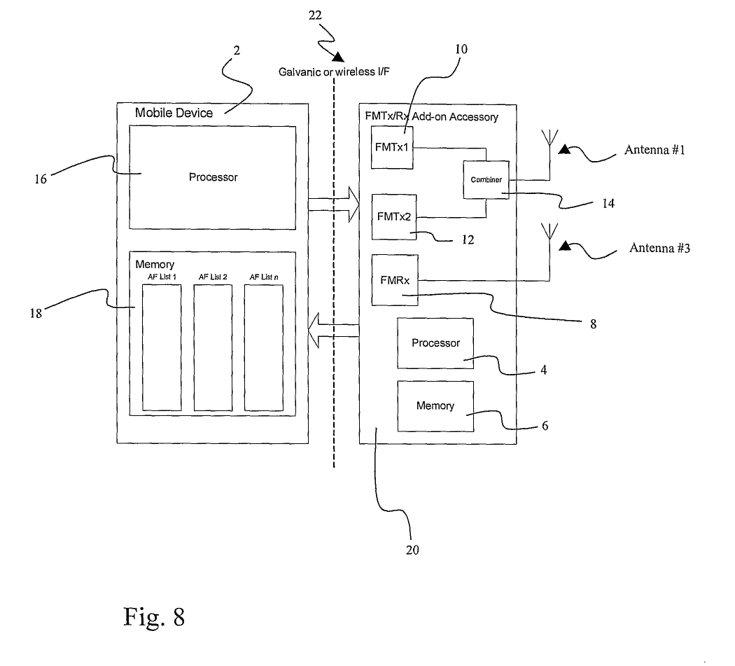

FIG. 8 shows an embodiment wherein the broadcast device of the invention is not installed within a mobile electronic device, but implemented as an add-on accessory 20 for existing mobile devices. The basic structure of the device 20 is similar to the one described in conjunction with FIG. 6. Two transmitters 10, 12 are connected with a shared antenna #1 via a combiner 14. The receiver 8 is connected with his own separate antenna #3. The processor 4 controls the device according to the inventive method, wherein alternative frequencies for the frequency jump can stored in a memory 6. Furthermore a data interface 22 is provided, which can be implemented e.g. with a wireless or galvanic connection (WLAN, Bluetooth, infra-red or the like). Via this data interface 22 the device 20 can communicate with a mobile electronic device 2, for example a mobile phone. The data interface may carry analogue and digital signals (e.g. audio, RDS and/or control data), or digital signals only (e.g. video, audio and/or text, RDS and/or control data).

The mobile device 2 comprises its own processor 16 and memory 18.

If a galvanic interface I/F was utilized, then it would be possible to power and communicate to the FMTx/Rx blocks using existing galvanic interfaces. In a corresponding alternative embodiment, there would be no need for the processor and memory blocks to exist in the add-on accessory. This could help in reducing cost and complexity. For the interface any suitable wired or wireless link can be utilized, including but not limited to WLAN, Bluetooth, infra-red and the like.

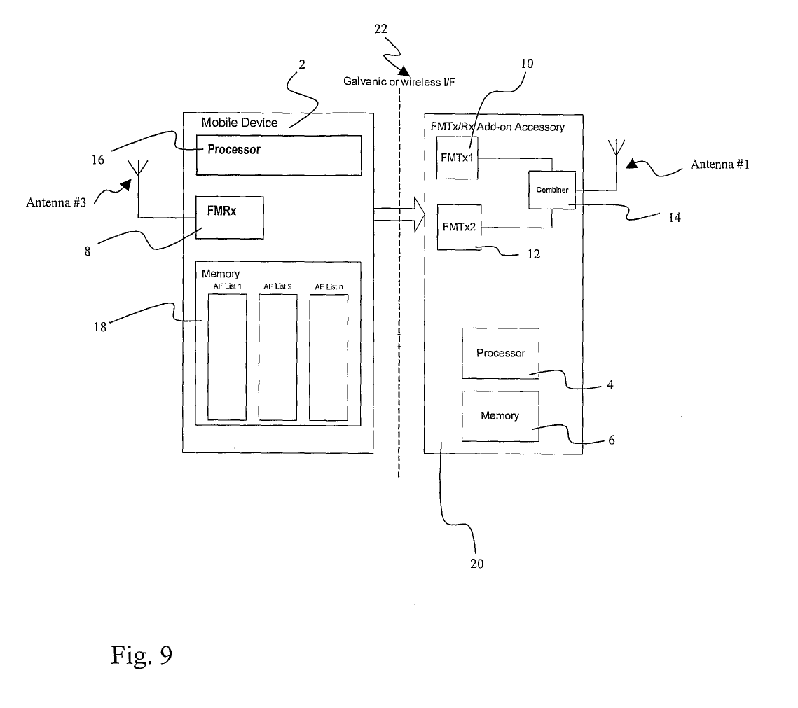

FIG. 9 shows an alternative embodiment wherein the broadcast device of the invention is not installed within a mobile electronic device, but implemented as an add-on accessory 20 for existing mobile devices. This embodiment is similar to the one depicted in FIG. 8, however some parts are arranged differently here. The major difference is that the receiver component 8 is not located in the accessory device 20, but in the mobile device 2. Correspondingly the antenna #3 connected therewith is also located in mobile device 2. Therefore the accessory device 20 only comprises the transmitters 10, 12 and their shared antenna #1. Furthermore the interface 22 is only uni-directional, that is, only transfers data from mobile device 2 to accessory device 20.

In this embodiment the mobile device 2 performs the scanning for free frequencies, using the receiver 8, and then informs the accessory device 20 of frequencies to use via the interface 22. Otherwise this embodiment works similarly to the one already described in FIG. 8 and does comprise the same components. Not shown are the respective power supplies, which can for example be rechargeable batteries.

An example use case for this embodiment could be a mobile device with an integrated FM radio capable of performing the scan. For such a device the accessory device would not need the receiver component.

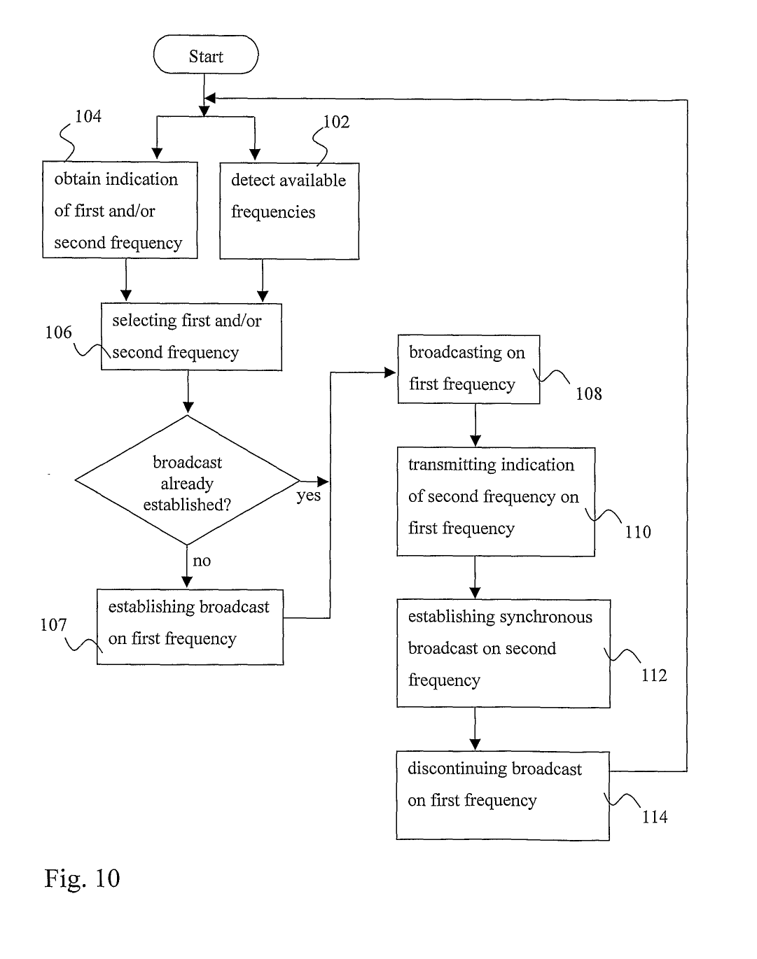

FIG. 10 is a flow diagram depicting the steps of an embodiment of the inventive method. In step 102 a scan for detecting free/available frequencies is performed. It is to be noted that “available” in the context of this invention means that no interfering signals are received, that is, signals that are strong enough to cause considerable interference. This is not to be confused with the frequency being totally “free” from any signals, because there will always be a certain signal level of noise or other weak signals. Just as an example, a frequency with received signal strength below 10% of the transmission power when received at 3 m distance of the broadcast transmitter or some other pre-determined value could be considered to be free.

In an alternative embodiment, in step 104 an indication of first and/or a second frequency is obtained. In this embodiment step 104 replaces step 102.

In either embodiment, in step 106 a first and/or a second frequency is selected, either based on the indication obtained in step 104 or from available frequencies detected in step 102. The indication obtained in step 104 may for example be an indication received from an external device, and may comprise a list of at least one frequency.

Selection might be based on the signal level measured on that frequency, a low noise-like signal level being preferable, the position of the new frequency, i.e. to favor those frequencies having the highest distance from used frequencies and/or frequencies likely to be subject to interference from harmonic and/or mixing products, or the next higher/lower frequency.

Depending on the hardware implementation it may occur that only those frequencies can be scanned which are not blocked by the current FM transmit frequency and possibly also mixing harmonics that fall within the band.

The selected first frequency is used to establish the radio broadcast in step 107, as there is already a transmission established. It is to be noted that steps 102 to 107 are steps which may be performed after powering on the radio transmission device, that is, may be initial steps. Therefore it is possible although not necessary to store a list of initially detected free frequencies, for later use, following step 102.

Free frequencies may be stored with a qualifier or weight parameter, or a classification e.g. from a range of 1 to 5 defining different signal qualities from 1 (e.g. 1 meaning it is a good channel with low signal interference) to 5 (meaning a bad channel with a high but still tolerable interference level). The qualifier or weight parameter may correspond to the measured signal level on that frequency. A low, noise-like signal level should be indicated by a “good” qualifier, e.g. a high value for the weight or a good classification. Also long term stability may contribute to the value of the qualifier or a good classification. Thus, frequencies that have never shown interference should receive a high weight or a good classification. Due to the past experience, such a classification indicates that the user is not likely to move into an area in which the frequency is used. If a list of alternative frequencies was already stored previously, this list is either updated or simply replaced.

In step 110 the chosen alternative frequency (second frequency) is indicated to a listening FM receiver, via the broadcast on the first frequency. In exemplary embodiments this can be achieved by using the Alternate Frequency (AF) feature of the Radio Data System (RDS). An synchronous broadcast with respect to the timing and payload content thereof is then established on the second frequency in step 112. For a certain time span or time overlap thus two transmissions on two different frequencies are present simultaneously. In step 114 the first transmission on the first frequency is discontinued.

Discontinuation can be achieved by fading out the transmission power, ranging from a slow decay to a sudden shut-off. While slow fading may enhance the chance that the listening FM receiver will follow to the new frequency, a sudden shut-off will minimize the time span until the jump in the receiver will take place. In an alternative embodiment the jump can be “forced” somehow, by stopping to transmit the PI code on the first frequency, irrespective of the way the transmission power is reduced/shut off.

Depending on the capabilities of e.g. an RDS capable FM receiver this can be adjusted accordingly, that is, the time required for complete fade out and rate/profile of fade out can be configured suitably. A too fast fading might result in the FM receiver not being able to recognize the fading correctly, and too slow fading might cause any interference on the first frequency to become disturbing, e.g. when the interferer increases in power rapidly. To save power consumption, the first transmission can be completely cancelled after a suitable time overlap of the two transmissions.

The above scheme can be repeated in order to ensure reliable operation. In this case the “second” frequency becomes the “first” frequency after the original first frequency has been shut off, and the scheme is started again, either at the beginning or at step 106. Either way, step 107 is omitted in the repeated scheme, as there will already be an established transmission in this case.

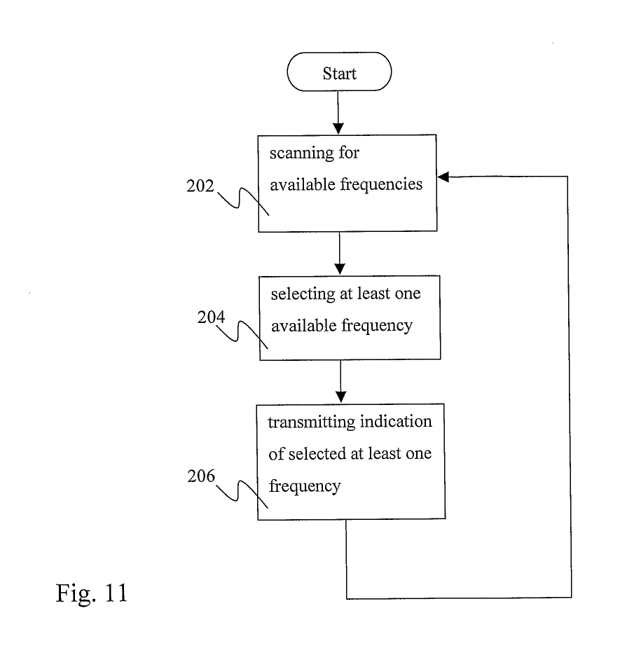

FIG. 11 shows an exemplary embodiment of a broadcast control method of the invention. In step 202 a radio frequency range is scanned for detecting available frequencies. In step 204 at least one detected available frequency is selected. An indication of this at least one selected frequency is then transmitted in step 206, to enable a receiver to perform the inventive broadcast method. This scheme can be repeated, in order to ensure reliable operation.

The frequency jump can be triggered by an interference that is detected on the current transmission frequency. However, the hardware has to support scanning on the current frequency in order to correctly implement this feature. Another possibility relies in more or less “random” frequency changes, thus enabling to scan the frequency that had just been left for interference. Such jumps might be performed according to a fixed time interval, e.g. every 10 minutes. While the latter may increase the risk of frequency jumps leading to drop outs in the reception (in case the FM receiver cannot make the change totally transparent at all times), it has the advantage that the operation is more reliable, and possible interferences can be recognized earlier if the frequency to be scanned is not used by the current transmission.

It is also possible to add a manual override function in the present invention, that is, to initiate the jump also responsive to a manual user input. Although the invention is directed to automate the frequency change as much as possible providing such “emergency” procedure can be advantageous. Therefore the radio transmission device of the invention can be provided with an input means like a button for enabling the user to manually initiate a jump. In embodiments where the transmission device is controlled by a connected mobile device, this input means can be implemented either in the mobile device or in the transmission device itself. In case it is implemented in the transmission or accessory device, a list of alternate frequencies may be required to be available therein, e.g. in form of a stored list of AF's.

In circumstances in which power consumption is not a concern, transmission can continuously take place on both frequencies. In this case, transmission on the first transmitter would use a first frequency and indicate a second frequency as alternate frequency (AF) of the RDS transmission. Transmission on the second transmitter would use the second frequency and indicate the first frequency as alternate frequency (AF) of the RDS transmission. Whenever interference occurs on one of the two frequencies, the receiver can always immediately switch to the other frequency to continue reception of the transmission. The first and second transmitters are only powered down for short intervals in order to make measurements on the first and second frequency. However, they should not be powered down simultaneously. Depending on the measurement results (e.g. in case of interference on one of the frequencies), a third frequency having no interference may be selected for the transmitter using the frequency experiencing the interference.

Assuming that the first frequency experiences interference, the first transmitter fades out transmission by reducing the transmit power. It restarts transmission on the third frequency. At the same time, the second transmitter will start indicating the third frequency as alternate frequency (AF) of the RDS transmission.

In case the radio transmission device is coupled with or installed in a mobile device or like, having a capability for determining a velocity of the device, a reduction in the power consumption can be achieved. The frequency of the scanning for free frequencies, which requires powering on the receiver component, can then be adapted to the traveling rate. In case the user is not moving at all (traffic jam) or only very slowly, the frequency of such re-scans can be reduced. In case of a high movement speed (highway travel) the frequency could be increased in order to improve the reliability. When used in a vehicular environment it may also be possible to make use of the odometer component of the vehicle in order to derive the movement rate. It should be noted that transmissions according to the invention may make use of the Program Identification (PI) code of RDS. Sending the identical PI code on the first and the second transmission (during the frequency jump time span) ensures that the FM receiver will identify the transmission correctly. The Alternate Frequency function of RDS uses the Program Identification (PI) code to determine which program is actually received. Switching to an alternative frequency is only performed if the receiver identifies the same PI code of the current reception frequency also in the transmission on the new frequency.

This code is a unique code identifying a certain transmitter, e.g. radio station. Within the concept of the present invention it is possible to “hardcode” such PI code into the transmitter of a device according to the invention. However there are also other ways of deriving the PI code “dynamically”, e.g. using the IMEI of a mobile device equipped with or connected to a device according to the invention. It should be ensured that the PI code is in every case unique and does not collide with a PI code allocated to a licensed broadcast station.

1. A method, comprising:
broadcasting data on a first radio frequency;
transmitting an indication of a second radio frequency via said broadcast on said first radio frequency;
establishing a synchronous second broadcast of said data on said second radio frequency; and
discontinuing transmission of said broadcast on said first radio frequency.

2-31. (canceled)

32. A method according to claim 1, further comprising:
obtaining an indication of at least one of said first and said second radio frequency; and
selecting said at least one of said first and said second frequency based at least in part on said indication.

33. A method according to claim 32, further comprising:
scanning a plurality of radio frequencies to detect available radio frequencies on which no interfering broadcasts or signals are currently received;
wherein said indication comprises a list comprising at least one frequency, wherein said list comprises at least one detected available frequency.

34. A method according to claim 33, further comprising:
storing a list of detected available frequencies or updating an already stored list.

35. A method according claim 1, wherein discontinuing transmission of said broadcast on said first frequency comprises one of:
shutting off said transmission; and
fading out said transmission.

36. A method according to claim 33, further comprising:
determining a velocity of the broadcast transmitter;
wherein said scanning is performed based at least in part on said velocity.

37. A method according to claim 1, wherein said data comprises at least one of:
audio data;
video data; and
textual data.

38. A method according to claim 1, wherein said broadcast is performed using frequency modulation (FM) radio transmission, and wherein transmitting said indication of said second frequency is performed according to the Alternate Frequency (AF) feature of the Radio Data System (RDS).

39. A computer program product comprising a computer-readable medium bearing computer program code embodied therein for use with a computer, the computer program code comprising:
code for broadcasting data on a first radio frequency;
code for transmitting an indication of a second radio frequency via said broadcast on said first radio frequency;
code for establishing a synchronous second broadcast of said data on said second radio frequency; and
code for discontinuing transmission of said broadcast on said first radio frequency.

40. Apparatus, comprising:
at least a first and a second radio transmitter; and
a controller adapted for establishing a broadcast of data on a first frequency using said first transmitter, transmitting an indication of a second frequency via said broadcast on said first transmitter, establishing a synchronous second broadcast of said data on said second frequency using said second transmitter, and discontinuing the transmission from said first transmitter.

41. Apparatus according to claim 40, further comprising:
an interface adapted for receiving an indication of at least one frequency;
wherein said controller is adapted for selecting at least one of said first and said second frequency based on said indication.

42. Apparatus according to claim 41, further comprising:
a memory;
wherein said indication comprises a list of frequencies,
wherein said controller is adapted for at least one of storing said received list in said memory and updating an already stored list based on said received list.

43. Apparatus according to claim 41, wherein said interface is selected from the group comprising:
an optical wireless interface;
a Bluetooth interface;
a wireless local area network, WLAN, interface;
a wire-based interface;
a Universal Serial Bus, USB, interface; and
a radio interface.

44. Apparatus according to claim 40, wherein discontinuing comprises shutting off or fading out the transmission power of said second transmitter.

45. Apparatus according to claim 40, wherein said transmitters are adapted for frequency modulation (FM) radio transmission, and said controller is adapted to transmit said indication of said second frequency according to the Alternate Frequency (AF) feature of the Radio Data System (RDS).

46. Apparatus according to claim 40, further comprising:
a receiver adapted to scan a plurality of radio frequencies;
wherein said controller is further adapted to control said receiver for detecting available radio frequencies on which no interfering broadcasts or signals are currently received, and for selecting at least one of said first and said second frequency from detected available frequencies.

47. Apparatus according to claim 46, further comprising:
an interface adapted for receiving velocity information;
wherein said controller is adapted to perform said detecting of available radio frequencies based at least in part on said velocity information.

48. Apparatus according to claim 46, further comprising:
a memory for storing a list of detected available frequencies;
wherein said controller is further adapted to cause at least one of storing of detected available frequencies in said memory and updating an already stored list.
